(19) United States
(12) Patent Application Publication
(10) Pub. No.: US 2005/0013494 A1
(43) Pub. Date: Jan. 20, 2005

(54) In-loop deblocking filter

(75) Inventors: Sridhar Srinivasan, Seattle, WA (US); Thomas W. Holcomb, Bothell, WA (US); Pohsiang Hsu, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/623,128

(22) Filed: Jul. 18, 2003

(51) Int. Cl. G06K 9/36; G06K 9/40

(52) U.S. Cl. 382/233; 382/268

(57) ABSTRACT

An improved deblocking filter for a video encoder/decoder reduces the computation expense of evaluating deblocking conditions. The improved deblocking filter bases the decision to filter block edges on sampled statistics of edge presence and strength, and also uses information of the motion vector, coded block pattern and transform type.

### TECHNICAL FIELD

The invention relates generally to in-loop deblocking filter techniques used with block transform-based digital media (e.g., video) compression to improve the rate-distortion performance of compressed video, as well as visual quality.

### BACKGROUND

Block based motion predictive video coding is by far the most commonly used technique for video compression. Standards such as MPEG-2, MPEG-4, Windows Media Video (WMV) versions 7/8/9, H.264 etc. are based on these block based motion video coding techniques. For example, these video compression techniques typically encode individual frames of video using intraframe compression or interframe compression. Intraframe compression techniques compress an individual frame, typically called I-frames or key frames, without reference to video data from other frames. Interframe compression techniques compress frames with reference to preceding and/or following frames, which are typically called predicted frames, P-frames, or B-frames.

The common detriment of block-based techniques is the creation of artificial illusory boundaries or contours between blocks in the decompressed video. These contours are referred to as “block (or blocking) artifacts” or “blockiness.” Blockiness is worse when the video bit rate is lower, and is highly undesirable.

Many techniques have been proposed to reduce block artifacts, including overlapped motion compensation, wavelets or large-support transforms, and deblocking filters. Of these, only deblocking filters have been found to be useful and effective in practical and commercial video encoders. This is possibly because deblocking filters are easily built to work with the best block based motion predictive codecs including the above standards.

By convention, a deblocking filter in video coding is interpreted as a filter that smoothes out block boundaries in decompressed video using a set of rules that are implicitly derived from data known to the decoder. In other words, deblocking filters generally require no additional side information to be sent in or with the compressed video stream. All the rules determining the necessity of filtering an edge, and the impulse response of the filter can be derived from information that is sent as part of the motion compensation process. Side information can be very expensive to transmit and may not provide the best use of scarce bandwidth.

The derivation of filter parameters (which include whether a filter should be applied to a given block edge, the filter support, and impulse response) from image data is usually a computationally expensive process. Further, the computational steps in this process usually involve many conditional operations. It is well recognized that conditional operations are undesirable, especially for hardware solutions, and for parallelism. Deblocking filters may take up to and beyond 30% of the decoding time. In particular, in-loop deblocking filters are often a bottleneck in decoder designs because they cannot be side stepped, unlike out-of-loop deblocking filters (often referred to as post-processing). On the positive side, in-loop deblocking filters (often called loop filters) give the best rate-distortion benefits. Therefore, it is very desirable to develop computationally efficient deblocking filters.

### SUMMARY

The innovations described herein are designed to reduce the slow, non-parallelizable steps in deblocking filters, such as the derivation of their parameters. The innovations used to achieve this benefit include the use of sampled statistics for determining edge presence and strength, and the use of information including motion vector, coded block pattern and transform type to filter out non-edge areas. These innovations are applicable for use with in-loop deblocking filters, although out-of-loop deblocking filters can equally benefit. Various deblocking filter embodiments can implement the innovations independently, or in combination.

Additional features and advantages of the invention will be made apparent from the following detailed description of embodiments that proceeds with reference to the accompanying drawings.

### BRIEF DESCRIPTION OF THE DRAWINGS

FIG. 1 is a block diagram of a suitable computing environment in which several described embodiments may be implemented.

FIG. 2 is a block diagram of a generalized video encoder system used in several described embodiments.

FIG. 3 is a block diagram of a generalized video decoder system used in several described embodiments.

FIG. 4 is a block diagram showing a motion estimation/compensation loop with deblocking of a reference frame in a video encoder.

FIG. 5 is a block diagram showing a motion compensation loop with deblocking of a reference frame in a video decoder.

FIG. 6 is a flowchart showing a determination of a deblocking condition for triggering application of the deblocking filter.

FIG. 7 is a diagram depicting examples of filtered block boundaries in P frames.

FIG. 8 is a diagram depicting pixel locations on boundary segments on which a block edge check for deblocking filtering is performed.

FIG. 9 is a digram depicting pixels in a boundary segment used in an edge strength determination.

FIG. 10 is a code listing showing pseudo-code of an edge strength function.

FIG. 11 is a code listing showing pseudo-code for a deblocking filtering operation.

FIG. 12 is a diagram depicting filtered vertical block boundary pixels in a macro-block.

### DETAILED DESCRIPTION

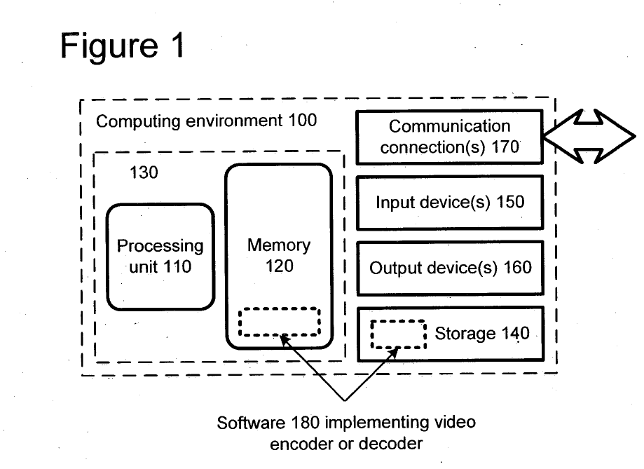

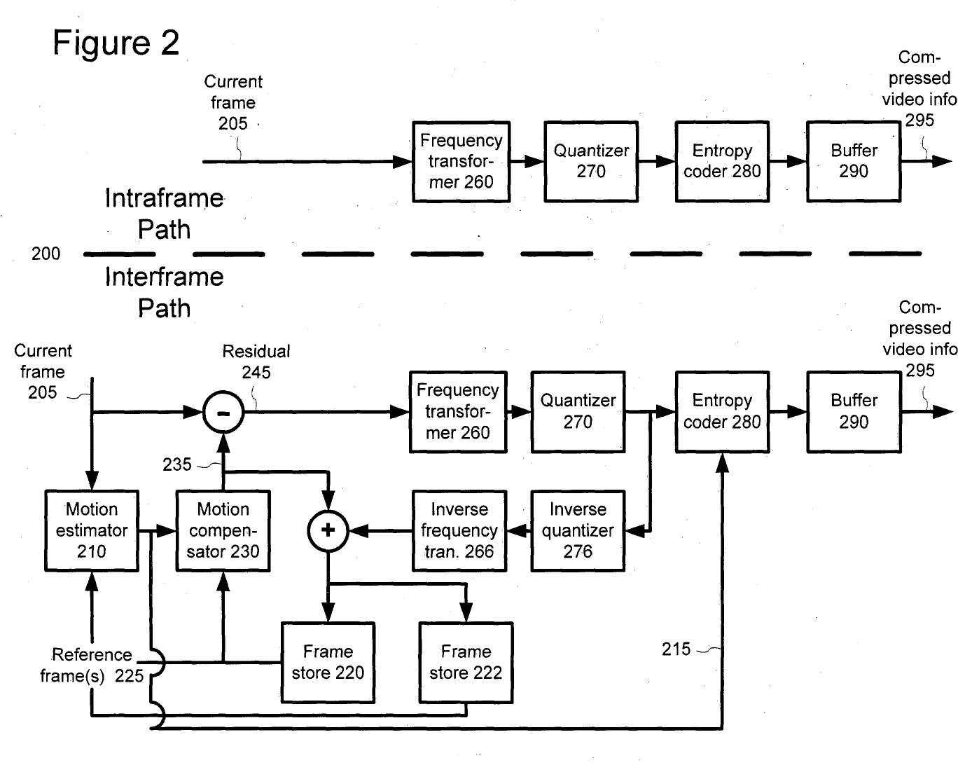

For purposes of illustration, the deblocking filter innovations summarized above are incorporated into embodiments of a video encoder and decoder (codec) illustrated in FIGS. 2-5, which in one embodiment implements the Windows Media Video codec standard. In alternative embodiments, the deblocking filter innovations described herein can be implemented independently or in combination in the context of other digital signal compression systems, and other video codec standards. In general, the depicted video encoder and decoder incorporating the deblocking filter techniques can be implemented in a computing device, such as illustrated in FIG. 1. Additionally, the video encoder and decoder incorporating the deblocking filter techniques can be implemented in dedicated or programmable digital signal processing hardware in other digital signal processing devices.

I. Computing Environment

FIG. 1 illustrates a generalized example of a suitable computing environment 100 in which several of the described embodiments may be implemented. The computing environment 100 is not intended to suggest any limitation as to scope of use or functionality, as the techniques and tools may be implemented in diverse general-purpose or special-purpose computing environments.

With reference to FIG. 1, the computing environment 100 includes at least one processing unit 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory, etc.), or some combination of the two. The memory 120 stores software 180 implementing a video encoder or decoder.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, DVDs, or any other medium which can be used to store information and which can be accessed within the computing environment 100. The storage 140 stores instructions for the software 180 implementing the video encoder or decoder.

The input device(s) 150 may be a touch input device such as a keyboard, mouse, pen, or trackball, a voice input device, a scanning device, or another device that provides input to the computing environment 100. For audio or video encoding, the input device(s) 150 may be a sound card, video card, TV tuner card, or similar device that accepts audio or video input in analog or digital form, or a CD-ROM or CD-RW that reads audio or video samples into the computing environment 100. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 100, computer-readable media include memory 120, storage 140, communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “estimate,” “choose,” “compensate,” and “apply” to describe computer operations in a computing environment. These terms are high-level abstractions for operations performed by a computer, and should not be confused with acts performed by a human being. The actual computer operations corresponding to these terms vary depending on implementation.

II. Generalized Video Encoder and Decoder

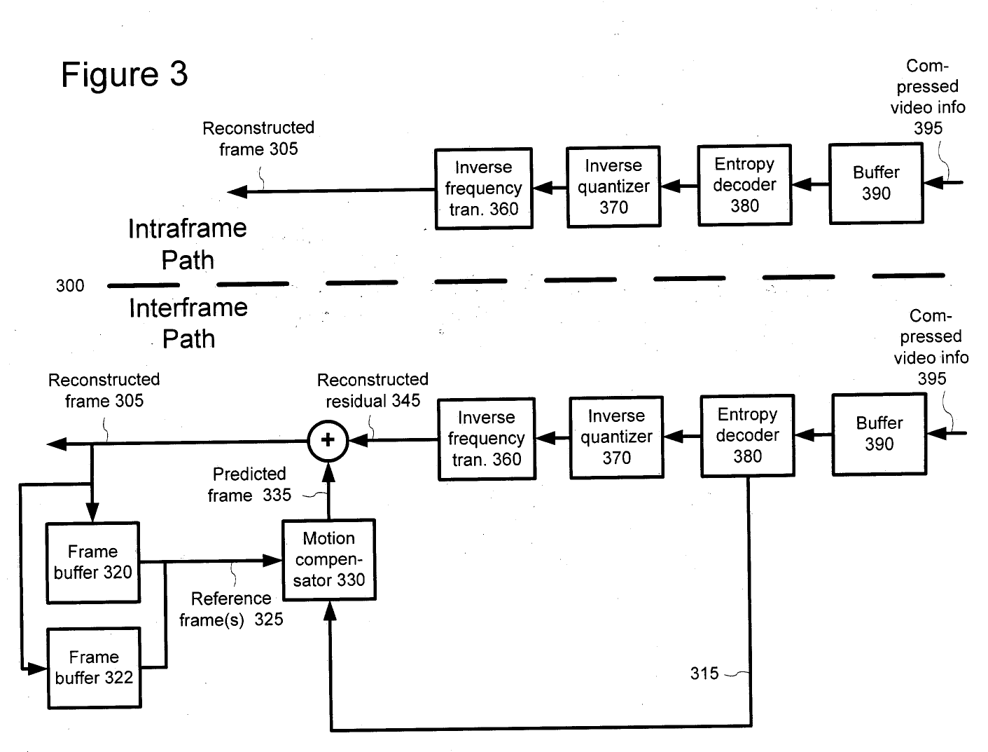

FIG. 2 is a block diagram of a generalized video encoder 200 and FIG. 3 is a block diagram of a generalized video decoder 300.

The relationships shown between modules within the encoder and decoder indicate the main flow of information in the encoder and decoder; other relationships are not shown for the sake of simplicity. In particular, FIGS. 2 and 3 generally do not show side information indicating the encoder settings, modes, tables, etc. used for a video sequence, frame, macroblock, block, etc. Such side information is sent in the output bit stream, typically after entropy encoding of the side information. The format of the output bit stream can be a Windows Media Video format or another format.

The encoder 200 and decoder 300 are block-based and use a 4:2:0 macroblock format with each macroblock including four 8×8 luminance blocks (at times treated as one 16×16 macroblock) and two 8×8 chrominance blocks. Alternatively, the encoder 200 and decoder 300 are object-based, use a different macroblock or block format, or perform operations on sets of pixels of different size or configuration than 8×8 blocks and 16×16 macroblocks.

Depending on implementation and the type of compression desired, modules of the encoder or decoder can be added, omitted, split into multiple modules, combined with other modules, and/or replaced with like modules. In alternative embodiments, encoder or decoders with different modules and/or other configurations of modules perform one or more of the described techniques.

A. Video Encoder

FIG. 2 is a block diagram of a general video encoder system 200. The encoder system 200 receives a sequence of video frames including a current frame 205, and produces compressed video information 295 as output. Particular embodiments of video encoders typically use a variation or supplemented version of the generalized encoder 200.

The encoder system 200 compresses predicted frames and key frames. For the sake of presentation, FIG. 2 shows a path for key frames through the encoder system 200 and a path for predicted frames. Many of the components of the encoder system 200 are used for compressing both key frames and predicted frames. The exact operations performed by those components can vary depending on the type of information being compressed.

A predicted frame (also called P-frame, B-frame for bi-directional prediction, or inter-coded frame) is represented in terms of prediction (or difference) from one or more reference (or anchor) frames. A prediction residual is the difference between what was predicted and the original frame. In contrast, a key frame (also called I-frame, intra-coded frame) is compressed without reference to other frames. Other frames also can be compressed without reference to other frames. For example, an intra B-frame (or B/I-frame), while not a true key frame, is also compressed without reference to other frames.

If the current frame 205 is a forward-predicted frame, a motion estimator 210 estimates motion of macroblocks or other sets of pixels of the current frame 205 with respect to a reference frame, which is the reconstructed previous frame 225 buffered in a frame store (e.g., frame store 220). If the current frame 205 is a bi-directionally-predicted frame (a B-frame), a motion estimator 210 estimates motion in the current frame 205 with respect to two reconstructed reference frames. Typically, a motion estimator estimates motion in a B-frame with respect to a temporally previous reference frame and a temporally future reference frame. Accordingly, the encoder system 200 can comprise separate stores 220 and 222 for backward and forward reference frames.

The motion estimator 210 can estimate motion by pixel, ½ pixel, ¼ pixel, or other increments, and can switch the resolution of the motion estimation on a frame-by-frame basis or other basis. The resolution of the motion estimation can be the same or different horizontally and vertically. The motion estimator 210 outputs as side information motion information 215 such as motion vectors. A motion compensator 230 applies the motion information 215 to the reconstructed frame(s) 225 to form a motion-compensated current frame 235. The prediction is rarely perfect, however, and the difference between the motion-compensated current frame 235 and the original current frame 205 is the prediction residual 245. Alternatively, a motion estimator and motion compensator apply another type of motion estimation/compensation.

A frequency transformer 260 converts the spatial domain video information into frequency domain (i.e., spectral) data. For block-based video frames, the frequency transformer 260 applies a discrete cosine transform [“DCT”] or variant of DCT to blocks of the pixel data or prediction residual data, producing blocks of DCT coefficients. Alternatively, the frequency transformer 260 applies another conventional frequency transform such as a Fourier transform or uses wavelet or subband analysis. If the encoder uses spatial extrapolation (not shown in FIG. 2) to encode blocks of key frames, the frequency transformer 260 can apply a re-oriented frequency transform such as a skewed DCT to blocks of prediction residuals for the key frame. In some embodiments, the frequency transformer 260 applies an 8×8, 8×4, 4×8, or other size frequency transforms (e.g., DCT) to prediction residuals for predicted frames.

A quantizer 270 then quantizes the blocks of spectral data coefficients. The quantizer applies uniform, scalar quantization to the spectral data with a step-size that varies on a frame-by-frame basis or other basis. Alternatively, the quantizer applies another type of quantization to the spectral data coefficients, for example, a non-uniform, vector, or non-adaptive quantization, or directly quantizes spatial domain data in an encoder system that does not use frequency transformations. In addition to adaptive quantization, the encoder 200 can use frame dropping, adaptive filtering, or other techniques for rate control.

If a given macroblock in a predicted frame has no information of certain types (e.g., no motion information for the macroblock and no residual information), the encoder 200 may encode the macroblock as a skipped macroblock. If so, the encoder signals the skipped macroblock in the output bit stream of compressed video information 295.

When a reconstructed current frame is needed for subsequent motion estimation/compensation, an inverse quantizer 276 performs inverse quantization on the quantized spectral data coefficients. An inverse frequency transformer 266 then performs the inverse of the operations of the frequency transformer 260, producing a reconstructed prediction residual (for a predicted frame) or a reconstructed key frame. If the current frame 205 was a key frame, the reconstructed key frame is taken as the reconstructed current frame (not shown). If the current frame 205 was a predicted frame, the reconstructed prediction residual is added to the motion-compensated current frame 235 to form the reconstructed current frame. A frame store (e.g., frame store 220) buffers the reconstructed current frame for use in predicting another frame. In some embodiments, the encoder applies a deblocking filter to the reconstructed frame to adaptively smooth discontinuities in the blocks of the frame.

The entropy coder 280 compresses the output of the quantizer 270 as well as certain side information (e.g., motion information 215, spatial extrapolation modes, quantization step size). Typical entropy coding techniques include arithmetic coding, differential coding, Huffman coding, run length coding, LZ coding, dictionary coding, and combinations of the above. The entropy coder 280 typically uses different coding techniques for different kinds of information (e.g., DC coefficients, AC coefficients, different kinds of side information), and can choose from among multiple code tables within a particular coding technique.

The entropy coder 280 puts compressed video information 295 in the buffer 290. A buffer level indicator is fed back to bit rate adaptive modules.

The compressed video information 295 is depleted from the buffer 290 at a constant or relatively constant bit rate and stored for subsequent streaming at that bit rate. Therefore, the level of the buffer 290 is primarily a function of the entropy of the filtered, quantized video information, which affects the efficiency of the entropy coding. Alternatively, the encoder system 200 streams compressed video information immediately following compression, and the level of the buffer 290 also depends on the rate at which information is depleted from the buffer 290 for transmission.

Before or after the buffer 290, the compressed video information 295 can be channel coded for transmission over the network. The channel coding can apply error detection and correction data to the compressed video information 295.

B. Video Decoder

FIG. 3 is a block diagram of a general video decoder system 300. The decoder system 300 receives information 395 for a compressed sequence of video frames and produces output including a reconstructed frame 305. Particular embodiments of video decoders typically use a variation or supplemented version of the generalized decoder 300.

The decoder system 300 decompresses predicted frames and key frames. For the sake of presentation, FIG. 3 shows a path for key frames through the decoder system 300 and a path for predicted frames. Many of the components of the decoder system 300 are used for decompressing both key frames and predicted frames. The exact operations performed by those components can vary depending on the type of information being decompressed.

A buffer 390 receives the information 395 for the compressed video sequence and makes the received information available to the entropy decoder 380. The buffer 390 typically receives the information at a rate that is fairly constant over time, and includes a jitter buffer to smooth short-term variations in bandwidth or transmission. The buffer 390 can include a playback buffer and other buffers as well. Alternatively, the buffer 390 receives information at a varying rate. Before or after the buffer 390, the compressed video information can be channel decoded and processed for error detection and correction.

The entropy decoder 380 entropy decodes entropy-coded quantized data as well as entropy-coded side information (e.g., motion information 315, spatial extrapolation modes, quantization step size), typically applying the inverse of the entropy encoding performed in the encoder. Entropy decoding techniques include arithmetic decoding, differential decoding, Huffman decoding, run length decoding, LZ decoding, dictionary decoding, and combinations of the above. The entropy decoder 380 frequently uses different decoding techniques for different kinds of information (e.g., DC coefficients, AC coefficients, different kinds of side information), and can choose from among multiple code tables within a particular decoding technique.

A motion compensator 330 applies motion information 315 to one or more reference frames 325 to form a prediction 335 of the frame 305 being reconstructed. For example, the motion compensator 330 uses a macroblock motion vector to find a macroblock in a reference frame 325. A frame buffer (e.g., frame buffer 320) stores previously reconstructed frames for use as reference frames. Typically, B-frames have more than one reference frame (e.g., a temporally previous reference frame and a temporally future reference frame). Accordingly, the decoder system 300 can comprise separate frame buffers 320 and 322 for backward and forward reference frames.

The motion compensator 330 can compensate for motion at pixel, ½ pixel, ¼ pixel, or other increments, and can switch the resolution of the motion compensation on a frame-by-frame basis or other basis. The resolution of the motion compensation can be the same or different horizontally and vertically. Alternatively, a motion compensator applies another type of motion compensation. The prediction by the motion compensator is rarely perfect, so the decoder 300 also reconstructs prediction residuals.

When the decoder needs a reconstructed frame for subsequent motion compensation, a frame buffer (e.g., frame buffer 320) buffers the reconstructed frame for use in predicting another frame. In some embodiments, the decoder applies a deblocking filter to the reconstructed frame to adaptively smooth discontinuities in the blocks of the frame.

An inverse quantizer 370 inverse quantizes entropy-decoded data. In general, the inverse quantizer applies uniform, scalar inverse quantization to the entropy-decoded data with a step-size that varies on a frame-by-frame basis or other basis. Alternatively, the inverse quantizer applies another type of inverse quantization to the data, for example, a non-uniform, vector, or non-adaptive quantization, or directly inverse quantizes spatial domain data in a decoder system that does not use inverse frequency transformations.

An inverse frequency transformer 360 converts the quantized, frequency domain data into spatial domain video information. For block-based video frames, the inverse frequency transformer 360 applies an inverse DCT [“IDCT”] or variant of IDCT to blocks of the DCT coefficients, producing pixel data or prediction residual data for key frames or predicted frames, respectively. Alternatively, the frequency transformer 360 applies another conventional inverse frequency transform such as a Fourier transform or uses wavelet or subband synthesis. If the decoder uses spatial extrapolation (not shown in FIG. 3) to decode blocks of key frames, the inverse frequency transformer 360 can apply a re-oriented inverse frequency transform such as a skewed IDCT to blocks of prediction residuals for the key frame. In some embodiments, the inverse frequency transformer 360 applies an 8×8, 8×4, 4×8, or other size inverse frequency transforms (e.g., IDCT) to prediction residuals for predicted frames.

When a skipped macroblock is signaled in the bit stream of information 395 for a compressed sequence of video frames, the decoder 300 reconstructs the skipped macroblock without using the information (e.g., motion information and/or residual information) normally included in the bit stream for non-skipped macroblocks.

C. Loop Filtering

Quantization and other lossy processing of prediction residuals can cause blocky artifacts (artifacts at block boundaries) in reference frames that are used for motion estimation of subsequent predicted frames. Post-processing by a decoder to remove blocky artifacts after reconstruction of a video sequence improves perceptual quality. Post-processing does not improve motion compensation using the reconstructed frames as reference frames, however, and does not improve compression efficiency. With or without post-processing, the same amount of bits is used for compression, but the post-processing improves perceived quality. Moreover, the filters used for deblocking in post-processing can introduce too much smoothing in reference frames used for motion estimation/compensation.

In one or more embodiments, a video encoder processes a reconstructed frame to reduce blocky artifacts prior to motion estimation using the reference frame. A video decoder processes the reconstructed frame to reduce blocky artifacts prior to motion compensation using the reference frame. With deblocking, a reference frame becomes a better reference candidate to encode the following frame. Thus, using the deblocking filter improves the quality of motion estimation/compensation, resulting in better prediction and lower bit rate for prediction residuals. The deblocking filter is especially helpful in low bit rate applications.

In some embodiments, following the reconstruction of a frame in a video encoder or decoder, the encoder/decoder applies a deblocking filter to 8×8 blocks in the reconstructed frame. The deblocking filter removes boundary discontinuities between blocks in the reconstructed frame, which improves the quality of subsequent motion estimation using the reconstructed frame as a reference frame. The encoder/decoder performs deblocking after reconstructing the frame in a motion compensation loop in order for motion compensation to work as expected. This contrasts with typical deblocking processes, which operate on the whole image outside of the motion compensation loop. The deblocking filter itself, however, can be the same or different than a filter used in post-processing. For example, a decoder can apply an additional post-processing deblocking filter to further smooth a reconstructed frame for playback after applying the deblocking filter for the frame as a reference frame for motion compensation. In alternative embodiments, the deblocking filter is applied to sets of pixels other than 8×8 blocks.

The encoder/decoder applies the deblocking filter across boundary rows and/or columns in the reference frame.

D. Deblocking Filter for Reference Frames

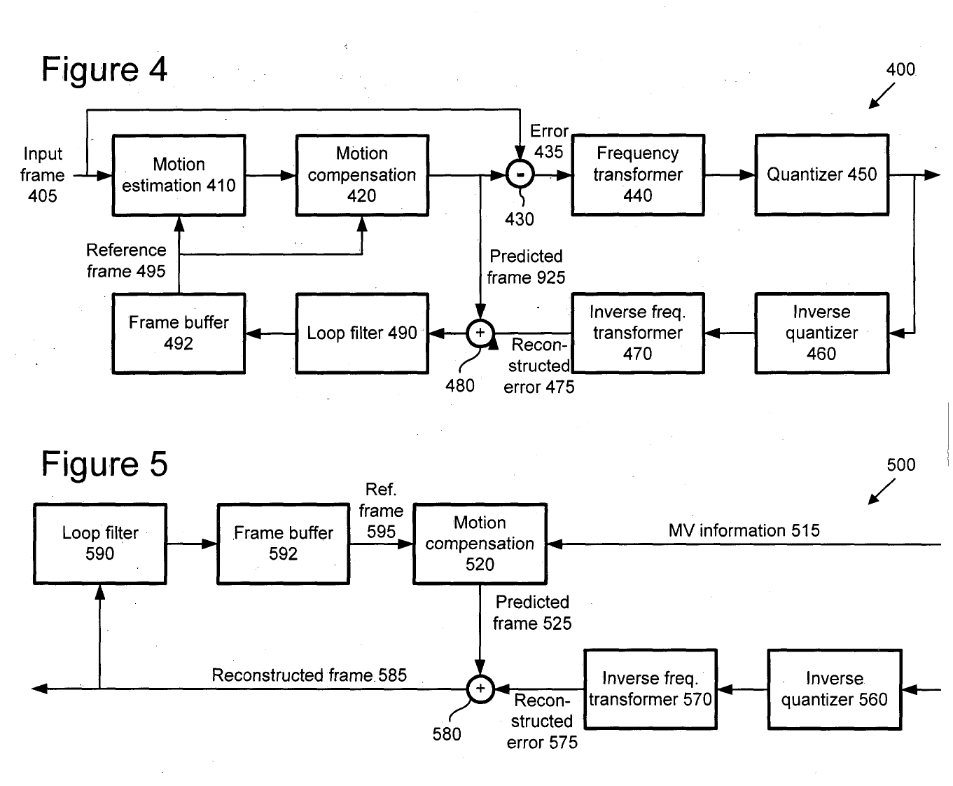

The deblocking filter smoothes boundary discontinuities between blocks in reconstructed frames in a video encoder or decoder. FIG. 4 shows a motion estimation/compensation loop in a video encoder that includes a deblocking filter. FIG. 5 shows a motion compensation loop in a video decoder that includes a deblocking filter.

With reference to FIG. 4, a motion estimation/compensation loop (400) includes motion estimation (410) and motion compensation (420) of an input frame (405). The motion estimation (410) finds motion information for the input frame (405) with respect to a reference frame (495), which is typically a previously reconstructed intra- or inter-coded frame. In alternative embodiments, the loop filter is applied to backward-predicted or bi-directionally-predicted frames. The motion estimation (410) produces motion information such as a set of motion vectors for the frame. The motion compensation (420) applies the motion information to the reference frame (495) to produce a predicted frame (425).

The prediction is rarely perfect, so the encoder computes (430) the error/prediction residual (435) as the difference between the original input frame (405) and the predicted frame (425). The frequency transformer (440) frequency transforms the prediction residual (435), and the quantizer (450) quantizes the frequency coefficients for the prediction residual (435) before passing them to downstream components of the encoder.

In the motion estimation/compensation loop, the inverse quantizer (460) inverse quantizes the frequency coefficients of the prediction residual (435), and the inverse frequency transformer (470) changes the prediction residual (435) back to the spatial domain, producing a reconstructed error (475) for the frame (405).

The encoder then combines (480) the reconstructed error (475) with the predicted frame (425) to produce a reconstructed frame. The encoder applies the deblocking loop filter (490) to the reconstructed frame and stores the reconstructed frame in a frame buffer (492) for use as a reference frame (495) for the next input frame. Alternatively, the loop filter (490) follows the frame buffer (492).

In alternative embodiments, the arrangement or constituents of the motion estimation/compensation loop changes, but the encoder still applies the deblocking loop filter to reference frames.

With reference to FIG. 5, a motion compensation loop (500) includes motion compensation (520) to produce a reconstructed frame (585). The decoder receives motion information (515) from the encoder. The motion compensation (520) applies the motion information (515) to a reference frame (595) to produce a predicted frame (525).

In a separate path, the inverse quantizer (560) inverse quantizes the frequency coefficients of a prediction residual, and the inverse frequency transformer (570) changes the prediction residual back to the spatial domain, producing a reconstructed error (575) for the frame (585).

The decoder then combines (580) the reconstructed error (575) with the predicted frame (525) to produce the reconstructed frame (585), which is output from the decoder. The decoder also applies a deblocking loop filter (590) to the reconstructed frame (585) and stores the reconstructed frame in a frame buffer (592) for use as the reference frame (595) for the next input frame. Alternatively, the loop filter (590) follows the frame buffer (592).

In alternative embodiments, the arrangement or constituents of the motion compensation loop changes, but the decoder still applies the deblocking loop filter to reference frames.

In the video encoder 200/decoder 300, the compressed bitstream does not need to provide any indication whether out-of-loop deblocking should be employed. The latter is usually determined by the decoder 300 based on simple rules and availability of additional compute cycles. Hints may be provided by the encoder in the bitstream indicating whether to use post-processing. On the other hand, the application of in-loop deblocking must be indicated within the bitstream to avoid drift or mismatch. This indication may be through a sequence based flag, and possibly using frame or sub-frame based flags. A decoder that encounters a frame indicating that it has been in-loop deblocked, must in turn decode and deblock that frame for bitstream compliance.

III. Deblocking Condition

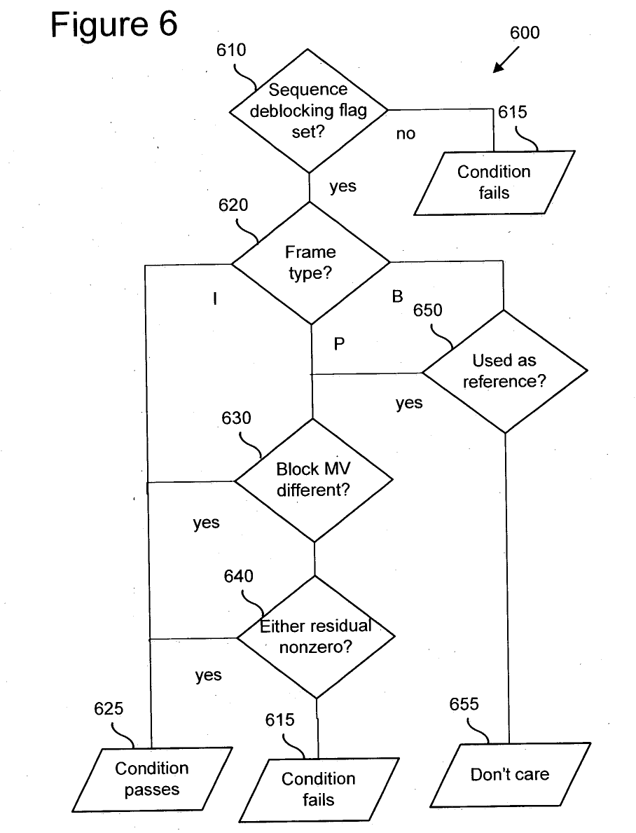

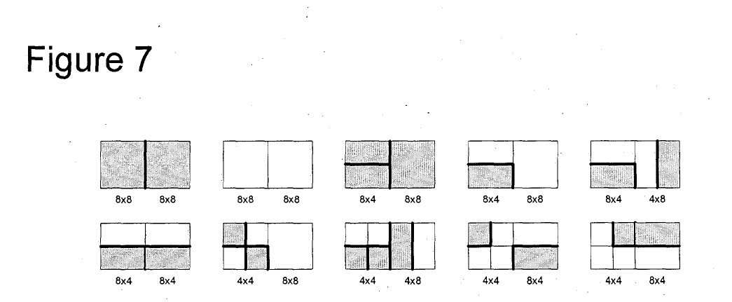

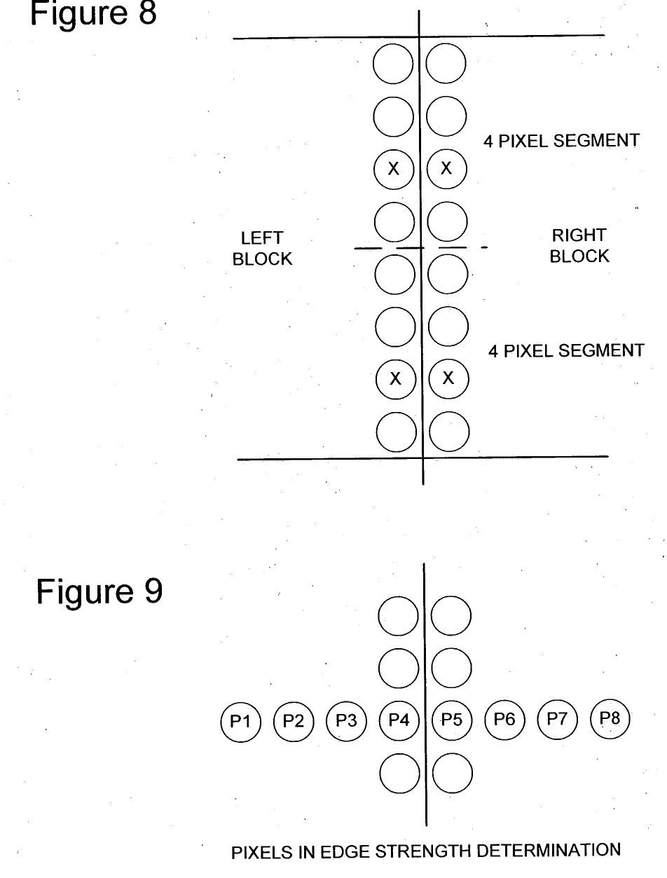

This section describes the frame, macroblock and block level conditions that trigger applications of the deblocking filter. FIG. 6 shows a process 600 used to determine the deblocking condition. This determines whether a given block edge is to be deblocked. Block edges that fail this condition are not deblocked. Those that pass the condition are then analyzed for edge strength (described below), in order to determine filter support and coefficients.

A block edge is defined as an edge that lies along the boundary of two adjacent blocks. In one embodiment of the video encoder 200/decoder 300 that uses the Windows Media Video standard, a block is generally an 8×8 pixel area. Sometimes, when smaller transforms such as on 8×4, 4×8 or 4×4 blocks are used in this standard, the block edge will mean the edge that is shared by two adjacent transform tiles. Accordingly, in the case of the Windows Media Video standard, block edges may be 8 or 4 pixels long. In other alternative embodiments, other block and block edges sizes can be used, e.g., 16 or 32 pixel edges, among others.

A. Sequence Level Condition

With reference to FIG. 6, the determination 600 for the deblocking condition first considers whether a sequence level deblocking bit or flag is set. Sequences that have the sequence level deblocking bit set pass the sequence level deblocking condition (at action 610), and the determination 600 then considers the frame level condition (at action 620). The bit can be explicitly transmitted for a block sequence in the compressed stream. This bit also may be implicitly set to zero for low-complexity bit streams such as for the simple profile. In cases where the sequence level deblocking flag is not set, the condition fails at result 615.

B. Frame Level Condition

Subject to the sequence level condition, and possible frame level bit indicating whether deblocking is required, the determination 600 of the frame level condition first considers the frame type at action 620, which in the Windows Media Video standard may be an intra frame (I), a bidirectional predicted frame (B) or predicted frame (P). All block edges in an intra frame pass the deblocking condition as indicated at result 625.

Blocks in a P-frame may pass the deblocking condition if they meet the macroblock, block and sub-block conditions (at actions 630-640).

When not used as a reference, deblocking is not binding on the encoder/decoder (indicated as the “don't care” result 655 in process 600). In the Windows Media Video standard, B-frames are not used as a reference, and therefore deblocking is not binding. However, for embodiments adhering to standards that permit B frames to be used as references, the process also considers the macroblock, block and sub-block conditions as for a P-frame as indicated at action 650.

C. Macroblock/Block/Sub-Block Level Conditions

In actions 630, 640, the deblocking condition determination 600 considers macroblock, block and sub-block level conditions, as follows:

All blocks edges in an I frame are deblocked (result 625).

All edges of Intra blocks in a P frame are deblocked (result 625).

All edges between two blocks having different motion vectors are deblocked (result 625).

All edges between two sub-blocks either (or both) of which has nonzero residuals are deblocked (result 625).

The deblocking condition otherwise fails (result 615).

From the above discussion, it can be seen that Intra blocks are always deblocked per this deblocking condition determination 600. The current Windows Media Video standard exclusively uses 8×8 blocks for coding Intra regions. The block edges for Intra blocks therefore always occur at 8n pixels from the top and left bounding edges of the frame. In embodiments using future or other video coding standards or formats, smaller or larger blocks may be used.

In the deblocking condition determination 600, predicted blocks (Inter coded blocks in P frames) have the most complex rules for the deblocking condition. In the current version of the Windows Media Video standard, inter-coded blocks may use an 8×8, 8×4, 4×8 or 4×4 inverse block transform to construct the samples that represent the residual error. Depending on the status of the neighboring blocks, the boundary between the current and neighboring blocks may or may not be deblocking filtered. The boundary between a block or subblock and a neighboring block or subblock is not filtered if both have the same motion vector and both have no residual error (no nonzero transform coefficients). Otherwise, such boundary is filtered.

FIG. 7 illustrates various examples of filtered block boundaries in P frames according to these deblocking condition rules. In this illustration, the shaded blocks are those with nonzero transform coefficients. Per the deblocking condition rules for P frames, the thick lines represent block edges that are deblocking filtered; the thin lines show those that aren't deblocking filtered. All blocks in FIG. 7 are assumed to be Inter coded.

These same deblocking condition rules apply to chrominance blocks, with the chrominance motion vector used in the block level test. Also, edges between Intra and Inter blocks are always deblocked.

IV. Block Edge Check and Filtering

For those blocks that pass the above-described deblocking condition, the video encoder 200/decoder 300 further performs a block edge check to determine whether to filter the respective block edge. Conventionally, deblocking filters have analyzed each location along a block edge for edge strength (i.e., for the presence of blockiness), which is computationally expensive. For improved computational efficiency, the video encoder 200/decoder 300 performs a block edge check at a single location per sub-segment of a block edge. This is done in the interest of computational speed and has a negligible cost in terms of reduced effectiveness.

In cases where the video coding standard uses more than one block edge length, the video encoder 200/decoder 300 sub-divides the block edges into segments (e.g., segments whose size is the largest common factor of the block edge lengths). The video encoder 200/decoder 300 then performs the edge strength test (for blockiness) at a single location along a segment.

For example, in embodiment of the video encoder 200/decoder 300 using the current Windows Media Video (WMV) standard, all block edges are either 4 or 8 pixels long. These are broken into continuous segments of 4 pixels length. FIG. 8 shows an example of an 8-pixel length block edge for such embodiment, which the video encoder 200/decoder 300 divides into two 4-pixel segments. In the diagram, the circles represent pixels, and the edge runs in the vertical direction, midway between the pixels on either side. The left and right pixels come from adjacent blocks. As another example, an alternative embodiment of the video encoder 200/decoder 300 for a coding standard with block edges of 12 and 18 pixel lengths may sub-divide the block edges into 6-pixel segments (6 being the largest common factor of 12 and 18).

The video encoder 200/decoder 300 then performs the edge strength test at a subset of locations (e.g., one location) along each segment. As previously remarked, a deblocking filter conventionally would test each row of pixels straddling the block edge for the presence of an artifact by means of a nonlinear edge strength measure, which is computationally expensive. For example, one embodiment of the video encoder 200/decoder 300 with segment size of 4 pixels performs the edge strength test at only one row of pixels in every four rows making up the segment (shown in the diagram as the pixels marked by an ‘x’). Likewise, for horizontal block edges, the video encoder/decoder checks only one column of pixels in every four. Alternative embodiments of the video encoder/decoder can perform the edge strength test at other numbers of the locations per block edge segment fewer than all locations, although one location per segment has proven sufficiently effective at identifying blockiness. Further, alternative embodiments of the video encoder/decoder can use different locations or patterns of locations within a segment, e.g., the first, second or fourth row in lieu of the third row location illustrated in FIG. 8.

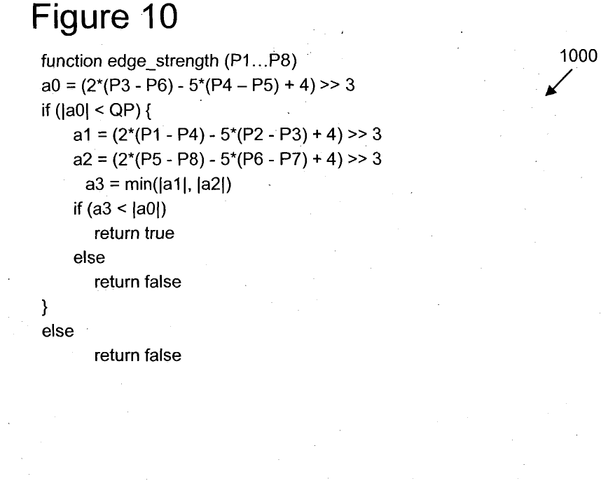

The video encoder 200/decoder 300 performs the edge strength test as a function of one or more pixels at either side of the block edge at the respective row location(s), e.g., the rows marked ‘x’ in FIG. 8. FIG. 9 depicts the pixels used in the edge strength test for a segment in one embodiment of the video encoder/decoder. FIG. 10 shows pseudo-code 1000 of the edge strength check function (“edge strength”) performed on these pixels at the respective location within a segment. In this illustrated edge check test embodiment, the video encoder 200/decoder 300 performs an edge check test that is a function of the values of four pixels on either side of the block edge at the per segment row location(s). FIG. 9 depicts the pre-determined pixels used for the test identified as pixels P1 through P8. Pixels P1 through P4 lie in the left block, and P5 through P8 in the right block. In the vertical direction, a similar operation is performed on the third column of pixels within a segment, with four pixels each in the top and bottom blocks used for the edge strength measure. Alternatively, the edge check test may be a function of more or fewer pixels within the row at the test location, e.g., three pixels to each side of the block edge.

The edge strength test function in this embodiment also is based on the quantization parameter-QP, which is a value that controls the amount of quantization by the quantizer 270 (FIG. 2). In this embodiment, the quantization parameter is generally related to the video quality resulting from compression (e.g., at higher quantization, the video quality decreases). In the edge strength test function, the quantization parameter is used as the basis to ease the threshold for applying the deblocking filter, such that the blockiness threshold for applying deblocking filtering is eased as the video quality decreases. In alternative embodiments, the edge strength test function can be based on other quality measurements, and can use other weightings of the pixels values as a measure of blockiness of the block edge segment.

The illustrated edge strength measure results in a true/false determination of whether to apply the deblocking filter on the respective block edge segment.

In general, various alternative embodiments of the video encoder/decoder with deblocking filter described here may be used with longer or shorter definitions of the segment, and with differently located samples for the edge strength measure.

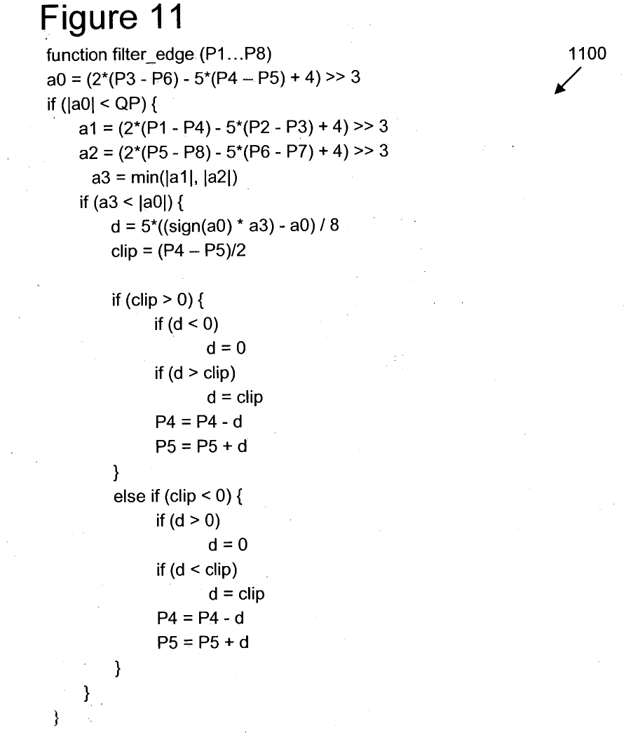

With reference now to FIG. 11, the block edge segments that pass the edge strength test are subject to filtering. FIG. 11 shows the pseudo-code 1100 of a deblocking filtering operation for one embodiment of the deblocking filter 490 (FIG. 4)/590 (FIG. 5) in the video encoder 200/decoder 300. In the illustrated deblocking filter operation, all rows (or columns) straddling the block edge are filtered. The illustrated filtering operation modifies the pixels adjacent to the edge for each row/column of the segment, which in the example shown in FIG. 9 are pixels P4 and PS. This filtering operation is applied to all pixel pairs on either side of the edge within a segment that passes the edge strength test. In particular, the function filter edge shown in FIG. 11 is repeated for all rows (or columns) of the segment.

It can be seen that some of the values calculated in the function filter_edge shown in FIG. 11 also are performed in the function edge_strength in FIG. 10. In some embodiments, the edge filtering function therefore can be modified to reuse the values from the edge strength test function to partially speed up the filtering operation on the same pixel row (or column) used in edge strength test.

In general, the edge strength test and filtering operations alternatively can use other weighted functions of the pixels in the respective rows or columns along the block edge, and also can be functions of other numbers of pixels on either side of the block edge (e.g., weighted functions of two, three, five or other number of pixels to each side of the block edge). The illustrated filtering operation also is based in part on the quantization parameter. Alternative embodiments can use filtering operations based on other quality measures, or that are independent of quality.

V. Interlace Deblocking Filter

Interlace content is often used in digital broadcast cable or television. Alternate rows of interlace content originate at the same time instant and are referred to as fields. Adjacent rows come from different fields, usually spaced a period of time, e.g., 1/60 second or 1/50 second apart. Loop filtering, as defined for P frames, is not desirable for smoothing out horizontal block edges. These may be smoothed using more advanced techniques that look at the specific pixel line alternating nature of interlaced data. For this reason, some embodiments of the video encoder 200/decoder 300 may do no in-loop deblocking on horizontal edges of interlaced video. On the other hand, these video encoder/decoder embodiments may smooth vertical block edges in much the same was as P frame block edges.

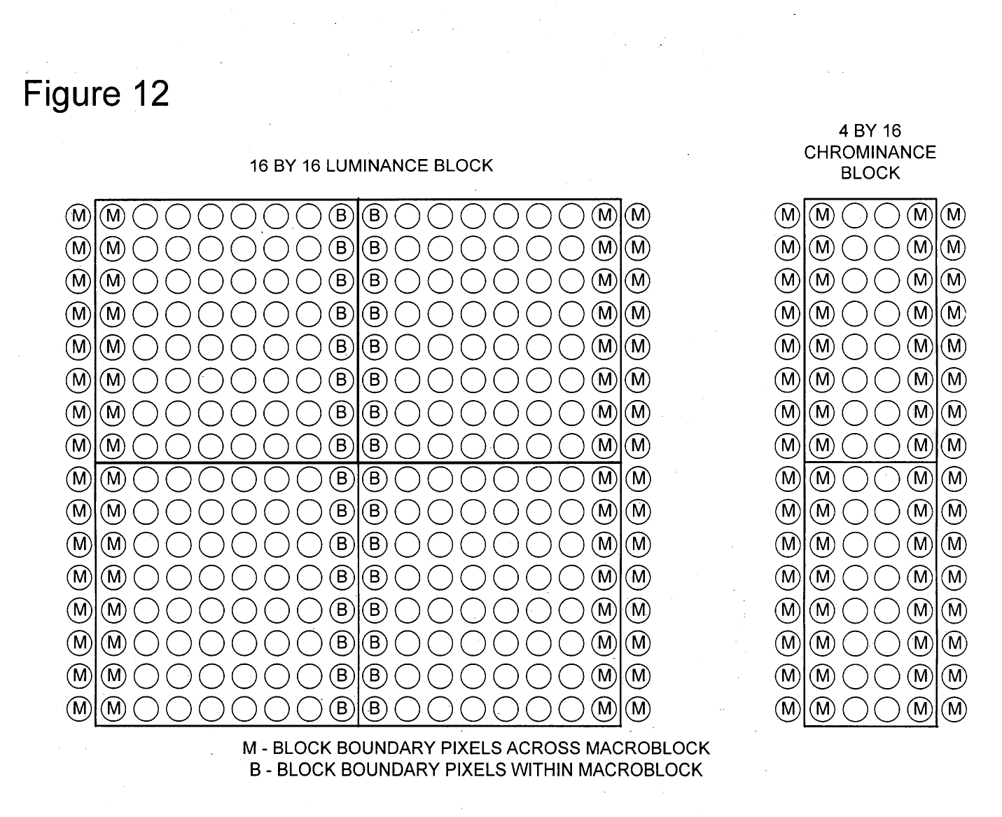

In one example embodiment of the video encoder/decoder with deblocking filter based on the current WMV standard, the video encoder/decoder first translates the motion vector and coded block pattern information used for the block level condition to the interlaced domain prior to filtering. This video encoder/decoder embodiment uses the following rule thai is dependent on six pieces of information: The current block (CB)'s and the left neighboring block (LB)'s type (i.e. frame MB or field MB), whether it is intra or inter coded, and its coded block pattern (i.e., information in the compressed stream that indicates whether there are nonzero transform coefficients, among other information). In general, the block boundary pixels are filtered unless the following condition is met. If the current block's (CB's) type is equal to the neighboring block's (LB's) type and both blocks are not intra coded and both block's coded block patterns (CBPs) are zero (indicating the blocks have no non-zero transform coefficients), then the block boundary is not filtered. The coded block pattern used in this embodiment is described in more detail in the U.S. patent application Ser. No. ______, entitled “Coding of Motion Vector Information,” filed concurrently with the present application, and hereby incorporated herein by reference. There is no additional test for chrominance block boundaries. Instead, chrominance block boundaries are filtered if the corresponding luminance block boundaries are filtered, i.e., there is a one to one correspondence between the luminance pixels and the chrominance pixels. This filtering of vertical block boundaries in a macroblock of interlaced video is illustrated in FIG. 12, which depicts pixels being filtered by marking with ‘M’. The marking ‘B’ in the diagram identifies pixels at block boundaries that are filtered for the luminance channel only. These rules apply to both I and P frames of the interlaced video.

Within a block edge segment that is to be filtered, the determination of edge strength for both horizontal and vertical edges may be carried out in a sampled manner, as for progressive data. Thus, the above-described deblocking filter innovations are directly applicable to interlaced content as well.

In view of the many possible embodiments to which the principles of our invention may be applied, we claim as our invention all such embodiments as may come within the scope and spirit of the following claims and equivalents thereto.

1. A method of reducing blocking artifacts in video compression, comprising:
for a block edge segment of a block portion of the video where the block edge segment has a length of plural pixels, sampling an edge strength measure at a subset of pixel locations less than all pixel locations along the block edge segment's length;
determining whether to filter the block edge segment based on the sampled edge strength measure;
filtering the block edge segment conditioned on the determination.

2. A method of reducing blocking artifacts in video compression, comprising:
evaluating a deblocking filter condition for a block edge between two blocks in a frame of the video based at least in part on a frame type, motion vectors of the blocks, and non-zero residual error;
determining whether to filter the block edge dependent at least in part upon the evaluation; and
if determined to filter the block edge, applying a deblocking filter to the block edge.

3. The method of claim 2 further comprising:
sampling an edge strength measure at locations less than a full length of the block edge; and
further basing the determination of whether to filter the block edge based on the sampled edge strength measure.

4. A method of reducing blocking artifacts in video compression, comprising:
determining whether to apply a deblocking filter to a block edge between two blocks in a frame of the video based at least in part on the blocks' types, whether the blocks are inter-frame or intra-frame coded, and the blocks' coded block pattern;
if determined to filter the block edge, applying a deblocking filter to the block edge.

5. The method of claim 4 wherein the code block patterns of the blocks are indicative of whether the blocks contain non-zero transform coefficients, and the determining whether to apply the deblocking filter based on the coded block pattern is based on the coded block patterns of the blocks indicating the blocks contain non-zero transform coefficients.

6. The method of claim 4 wherein the determining whether to apply the deblocking filter comprises determining to apply the deblocking filter unless the blocks' have matching types, the blocks are not intra-coded, and the coded block patterns are zero.

7. A digital video signal processing system comprising:
a video encoder/decoder;
an in-loop deblocking filter in the video encoder/decoder; and
a deblocking condition evaluator for controlling application of the in-loop deblocking filter to an encoded block within a frame of video according to an evaluation of a deblocking condition based at least in part upon a frame type, motion vectors of the block, and residual error of the blocks being non-zero.

8. A computer readable medium having software programming of a video encoder or decoder carried thereon, including code executable on a computer to perform a method of reducing blocking artifacts in compressed video processed by the video encoder or decoder, the method comprising:
for a block edge segment of a block portion of the video where the block edge segment has a length of plural pixels, sampling an edge strength measure at a subset of pixel locations less than all pixel locations along the block edge segment's length;
strength measure;
filtering the block edge segment conditioned on the determination.
